(19) United States
(12) Patent Application Publication
(10) Pub. No.: US 2026/0242904 A1
(43) Pub. Date: Aug. 20, 2026

(54) NON-ORIENTED ELECTRICAL STEEL PLATE AND MANUFACTURING METHOD THEREFOR

(71) Applicant: Baoshan Iron & Steel Co., Ltd., Shanghai (CN)

(72) Inventors: Feng Zhang, Shanghai (CN); Xuejun Lv, Shanghai (CN); Xianshi Fang, Shanghai (CN); Yunwei Hao, Shanghai (CN); Bo Wang, Shanghai (CN)

(21) Appl. No.: 18/994,007

(22) PCT Filed: Jul. 20, 2023
(86) PCT No.: PCT/CN2023/108440

§ 371 Date: Jan. 13, 2025

(30) Foreign Application Priority Data
Jul. 20, 2022 (CN) 202210858578.5

(51) Int. Cl. C22C 38/02; C21D 6/00; C21D 8/1216; C21D 8/1244; C21D 8/1277; C21D 9/46; C22C 38/00; C22C 38/04; C22C 38/06; C22C 38/18

(52) U.S. Cl. CPC C22C 38/02; C21D 6/008; C21D 8/1222; C21D 8/1233; C21D 8/1261; C21D 8/1272; C21D 8/1283; C21D 9/46; C22C 38/002; C22C 38/004; C22C 38/04; C22C 38/06; C22C 38/18

(57) ABSTRACT

The present disclosure discloses a non-oriented electrical steel plate, which comprises, in addition to Fe and inevitable impurities, the following chemical elements in percentage by mass: C: 0.001~0.004%, Si: 2.0~3.8%, Mn: 0.05~1.0%, Al≤1.51%, Ca: 0.0003~0.01%, Cr: 0.005~0.4%. In addition, the present disclosure also discloses a method for manufacturing the above-mentioned non-oriented electrical steel plate, which comprises the following steps: (1) Smelting and casting; (2) Heating and rolling, when the continuous casting slab is heated in a heating furnace and a temperature is raised to 1020° C. or more, a heating rate is controlled to be 0.8~2.0° C./min; a final rolling temperature is ≥880° C., and a residence time after final rolling and before laminar flow cooling is controlled to be 5-40s; (3) Normalizing annealing; (4) pickling; (5) Cold rolling; (6) Continuous annealing; (7) Coating an insulation coating.

### TECHNICAL FIELD

The present disclosure relates to a steel plate and a manufacturing method therefor, in particular to a non-oriented electrical steel plate and a manufacturing method therefor.

### BACKGROUND

In recent years, with the rapid popularization of environmental protection concepts, in order to improve the natural environment, people generally hope to further save electrical energy consumption by improving electricity consuming efficiency. Thus, the requirements for non-oriented electrical steel plates with a thin specification, a high magnetic induction, and a low iron loss are becoming higher and higher currently.

In order to meet market demand, there is an urgent need to develop a new non-oriented electrical steel plate with thin specification, high magnetic induction, low iron loss, and excellent mechanical properties, which can be used as a steel for driving motors of new energy vehicles, a steel for compressors of inverter air conditioners, and a steel for high-speed rotating power tools.

In the current prior art, for the steel plate with thin specification, the thickness of the finished product commonly used in the industry is generally controlled to be 0.35 mm or less, or even 0.27 mm or less. However, due to the reasons such as that the magnetic circuit or yoke width of the rotor core is becoming narrower and narrower for the design requirements of miniaturization and lightweighting of the motor core, and the inertia centrifugal force of the rotor core is very large during high-speed operation, thin steel plates are prone to have problems such as deformation and fracture. Therefore, currently, when preparing non-oriented electrical steel plates, the market and users have increasingly high requirements for the strength of the finished thin steel plates.

In addition, when non-oriented electrical steel plates are practically prepared for use as stator cores, it is expected to have lower iron loss P_{1.0/400} and excellent magnetic induction B₅₀₀₀ after stress relief annealing. Therefore, it is of great practical significance to develop a non-oriented silicon steel with thin specification, high strength, low iron loss and high magnetic induction and a manufacturing method therefor.

For this demand, some researchers have conducted extensive research and achieved certain research results, but the objective application effects of these patent technical documents is not very ideal:

For example, the Chinese patent document with the publication number of CN107974620A, the publication date of May 1, 2018, and the title of “A Non-oriented Silicon Steel with Yield Strength≥600 MPa for High Speed Motor Rotors and Productive Method” discloses a high yield strength non-oriented silicon steel and manufacturing method therefor, and the high yield strength non-oriented silicon steel has a chemical composition in wt % of C: 0.001-0.003%, Si: 2.6-3.4%, Mn: 0.20-0.60%, P≤0.005%, S≤0.005%, Als: 0.75-0.95%, N: 0.002-0.006%, Nb: 0.053-0.20%. The production steps adopted in this technical solution comprise: smelting in a converter and casting into a slab; heating a continuous casting slab; conventional roughing rolling and finishing rolling; normalizing; cold rolling after pickling; continuous annealing. The finished steel plate with a thickness of not exceeding 0.35 mm manufactured by this technical solution has a yield strength of ≥600 MPa, a tensile strength of ≥700 MPa, a P_{1.0/400} of ≤35W/kg, and a B₅₀₀₀ of ≥1.60T. In this patent document, both the tensile strength and yield strength of the finished steel plate are very excellent, reaching 700 MPa or more, 600 MPa or more respectively, but the iron loss P_{1.0/400} is as high as 35 W/kg and the magnetic induction B₅₀₀₀ is as low as 1.60 T. Its performance is still poor.

For another example, the Japanese patent document with the publication number of JP 2012-136764, the publication date of Jul. 19, 2012, and the title of “Manufacturing Method for a High-Strength Electromagnetic Steel Plate” discloses a manufacturing method for a high-strength electromagnetic steel plate, which has a chemical composition in wt % of Si: 3.5~5.0%, S: 0.0005~0.0030%, Ca: 0.0015% or more, Sn and/or Sb: 0.01~0.1%. A high-strength electromagnetic steel plate was obtained by this technical solution comprising casting into a slab by an arc-continuous-casting machine, and then hot rolling, normalizing, one cold rolling and continuous annealing in sequence. Wherein, the surface center temperature of the continuous casting slab is not lower than 700° C., the normalizing temperature is 850-1000° C., the soaking time is 10s-10 min, and the hot-rolled steel plate is required to achieve 100% recrystallization with a grain size of 80-300 μm after normalizing; During continuous annealing, the annealing temperature is 670-800° C., the soaking time is 2s-1 min and it is required to achieve 30-95% recrystallization, and the length of recrystallized grain group is 2.5 mm or less in the rolling direction. In the examples of this patent document, a tensile strength of nearly 700 MPa and an iron loss of P_{10/400} up to 20 W/kg or more are provided, but the yield strength of the finished steel plate is not mentioned.

Based on this, being different from the above-mentioned existing technical solutions, the inventors design and expect to obtain a new non-oriented electrical steel plate with thin specification, high strength, low iron loss, and high magnetic induction and manufacturing method therefor, to satisfy the demands of the market and users.

### SUMMARY

One of the objects of the present disclosure is to provide a non-oriented electrical steel plate. By means of reasonable design of chemical composition and optimized manufacturing processes, the non-oriented electrical steel plate can achieve excellent yield strength, tensile strength and electromagnetic properties (the yield strength is ≥600 MPa, the tensile strength is ≥700 MPa, the iron loss P_{10/400} is ≤18.0 W/kg, and the magnetic induction B₅₀₀₀ is ≥1.62T), meet the requirements of low cost and low loss, and have the characteristics of low cost, wide application range, and good stability, etc.

In order to achieve the above-mentioned object, the present disclosure provides a non-oriented electrical steel plate. The non-oriented electrical steel plate comprises, in addition to Fe and inevitable impurities, the following chemical elements in percentage by mass:
C: 0.001~0.004%, Si: 2.0~3.8%, Mn: 0.05~1.0%, Al≤1.51%, Ca: 0.0003~0.01%, Cr: 0.005~0.4%.

Preferably, in the non-oriented electrical steel plate of the present disclosure, the chemical elements in percentage by mass are:
C: 0.001~0.004%, Si: 2.0~3.8%, Mn: 0.05~1.0%, Al≤1.51%, Ca: 0.0003~0.01%, Cr: 0.005~0.4%; the balance being Fe and inevitable impurities.

In the non-oriented electrical steel plate according to the present disclosure, the design principle of each chemical element is as follows:

C: The C element can strongly hinder the growth of the grains in the finished strip steel. The C element is easy to combine with Nb, V, Ti, etc. to form fine precipitates, thereby causing loss increasing and arising magnetic aging. Thus, the C element content in steel must be strictly controlled at 0.004% or less. But it should be noted that the content of C element in steel should not be too low. When the content of C element in steel is less than 0.001%, it is not conducive to improve the mechanical strength of the finished steel plate. Based on this, in order to fully exert the beneficial effects of C element, the mass percentage content of C element is controlled between 0.001 and 0.004% in the non-oriented electrical steel plate according to the present disclosure.

Si: Adding an appropriate amount of Si element to steel can not only increase the electrical resistivity of the steel, but also effectively reduce the iron loss of the steel. When the Si element content in the steel is higher than 3.8%, it will significantly reduce the magnetic induction of the steel and easily lead to breaking of the strip during cold rolling; When the Si element content in the steel is less than 2.0%, the effect of reducing the iron loss of the steel is not significant. Based on this, in order to fully exert the beneficial effects of Si element, the mass percentage content of Si element is controlled between 2.0 and 3.8% in the non-oriented electrical steel plate according to the present disclosure.

Mn: The Mn element can be combined with S element to form MnS, which can effectively reduce the hazard to the magnetic property of steel. When the content of the Mn element in steel is less than 0.05%, the S fixation effect of the Mn element is poor; When the content of the Mn element in steel exceeds 1.0%, the manufacturing cost of the steel will be significantly increased. Therefore, in order to fully exert the beneficial effects of the Mn element, the mass percentage content of the Mn element is controlled between 0.05% and 1.0% in the non-oriented electrical steel plate according to the present disclosure.

Al: The Al element can have effects of increasing the electrical resistivity of materials, thereby promoting grain size growth and reducing iron loss of the materials and so on. When the content of Al added to the steel is too high (more than 1.51%), it will cause casting difficulties during continuous casting, lead to a significant increase of manufacturing costs, and significantly deteriorate the stability of cold rolling. Based on this, in the non-oriented electrical steel plate according to the present disclosure, the mass percentage content of the Al element is controlled to be 0<Al≤1.51%.

Ca: Ca is a strong deoxidizing and desulfurizing element. Ca can easily form large particle inclusions that are prone to float and be removed, and effectively reduce the hazard to the magnetic property of steel. Therefore, in order to fully exert the beneficial effects of the Ca element, it is necessary to add 0.0003% or more Ca to the steel. But it should be noted that the content of the Ca element in steel should not be too high. When more than 0.01% Ca element are added to the steel, it will cause abnormal grain refinement and a reduction in the proportion of the favorable crystal texture in the finished steel plate, thereby deteriorating the magnetic property of the steel. Thus, in order to exert the beneficial effects of the Ca element, the mass percentage content of the Ca element is controlled between 0.0003 and 0.01% in the non-oriented electrical steel plate according to the present disclosure.

Certainly, in some preferred embodiments, in order to achieve better implementing results, the mass percentage content of the Ca element can be further preferably controlled between 0.0005% and 0.004%.

Cr: The Cr element can be combined with N element to form Cr₂N, which can effectively reduce the hazard to the magnetic property of steel. When the content of the Cr element in steel is less than 0.005%, the N fixation effect of the Cr element is poor, so it needs to add 0.005% or more Cr to the steel. But it should be noted that the content of the Cr element in steel should not be too high. When more than 0.4% Cr is added to the steel, it will cause abnormal grain refinement and a reduction in the proportion of the favorable crystal texture in the finished steel plate, thereby deteriorating the magnetic property of the steel. Based on this, considering the influence of the Cr element content on steel performance, the mass percentage content of the Cr element is controlled between 0.005% and 0.4% in the non-oriented electrical steel plate according to the present disclosure.

Preferably, in the non-oriented electrical steel plate according to the present disclosure, among the inevitable impurities, P≤0.02%, S≤0.002%, N≤0.004%, 0≤0.005%.

In the non-oriented electrical steel plate according to the present disclosure, P element, S element, N element, and O element are all impurity elements of the non-oriented electrical steel plate, which are impurity elements introduced into the steel from raw and auxiliary materials or production process. If the technical conditions permit, in order to obtain the steel with better performance and better quality, the content of impurity elements in the steel should be reduced as much as possible.

P: When the mass percentage content of P element in steel exceeds 0.02%, it is easy to cause the occurrence of cold brittleness and reduce the manufacturability during cold rolling process. Therefore, in the non-oriented electrical steel plate according to the present disclosure, the mass percentage content of P element is controlled to be: P≤0.02%.

S: When the content of S element in steel exceeds 0.002%, it will greatly increase the quantity of harmful inclusions such as MnS and Cu₂S, thereby leading to the deterioration of iron loss of the steel. Thus, in the non-oriented electrical steel plate according to the present disclosure, the mass percentage content of the S element is controlled to be: S≤0.002%.

N: When the mass percentage content of the N element in steel exceeds 0.004%, the precipitates of N with Nb, V, Ti, Al, Cr, etc will have a sharp increase in the amount and a coarsening of size, which is not conducive to improve the mechanical strength of the finished steel plate and reduce the iron loss of the finished steel plate. Therefore, in the non-oriented electrical steel plate according to the present disclosure, the mass percentage content of N element is controlled to be: N≤0.004%.

O: When the mass percentage content of O element in steel exceeds 0.005%, the quantity of oxide inclusions will increase greatly, which is not conducive to adjusting the proportion of the beneficial inclusions and will deteriorate the magnetic properties of the steel. Therefore, in the non-oriented electrical steel plate according to the present disclosure, the mass percentage content of the O element is controlled to be: O≤0.005%.

Preferably, in the non-oriented electrical steel plate according to the present disclosure, the Ca element content is 0.0005-0.004%.

Preferably, in the non-oriented electrical steel plate of the present disclosure, the nitride inclusions in the steel include individual Cr₂N, AlN or TiN, and composite inclusions formed by at least two of AlN, Cr₂N and TiN.

Preferably, in the non-oriented electrical steel plate according to the present disclosure, the volume ratio of nitride inclusions [N]_{I} in the steel to all of oxide inclusions [O]_{I}, sulfide inclusions [S]_{I} and nitride inclusions [N]_{I} in the steel satisfies: 0.42≤[N]_{I}/([O]_{I}+[S]_{I}+[N]_{I})≤0.85.

Preferably, in the non-oriented electrical steel plate according to the present disclosure, the volume ratio of nitride inclusions with a size of 0.2-0.5 μm to oxide inclusions, sulfide inclusions and nitride inclusions with a size of 0.2-2.0 μm is 0.7~1.0.

Preferably, in the non-oriented electrical steel plate according to the present disclosure, the thickness of the non-oriented electrical steel plate is 0.15~0.35 mm.

Preferably, in the non-oriented electrical steel plate according to the present disclosure, the non-oriented electrical steel plate has a yield strength of ≥600 MPa, a tensile strength of ≥700 MPa, an iron loss P_{10/400} of ≤18.0 W/kg, and a magnetic induction B₅₀₀₀ of ≥1.62T.

Correspondingly, another object of the present disclosure is to provide a method for manufacturing the above-mentioned non-oriented electrical steel plate. The manufacturing method is simple and feasible. Through the manufacturing method, a non-oriented electrical steel plate with excellent mechanical and electromagnetic properties can be obtained, and the non-oriented electrical steel plate has a yield strength of ≥600 MPa, a tensile strength of ≥700 MPa, an iron loss P_{10/400≤18.0} W/kg, and a magnetic induction B₅₀₀₀≥1.62T.

In order to achieve the above-mentioned object of the present disclosure, the present disclosure provides a method for manufacturing a non-oriented electrical steel plate, comprising the following steps:
(1) smelting and casting to obtain a continuous casting slab;
(2) heating and rolling to obtain a steel plate, wherein when the continuous casting slab is heated in a heating furnace and a temperature is raised to 1020° C. or more a heating rate is controlled to be 0.8~2.0° C./min; a final rolling temperature is controlled to be ≥880° C., and a residence time after final rolling and before laminar flow cooling is controlled to be 5-40s;
(3) normalizing annealing the steel plate;
(4) pickling;
(5) cold rolling;
(6) continuous annealing to obtain a finished steel plate;
(7) coating an insulation coating on a surface of the finished steel plate.

In the present disclosure, the inventors optimize the design of the steel's chemical composition and limits the reasonable manufacturing process. After smelting and casting to obtain a continuous casting slab, by optimizing the heating and temperature rising process and hot rolling process for the continuous casting slab, and combining with subsequent normalizing annealing, pickling, cold rolling, continuous annealing and coating process, a non-oriented electrical steel plates with excellent yield strength, tensile strength, and electromagnetic properties can be effectively manufactured. The manufactured non-oriented electrical steel plate can effectively meet the requirements of low cost and low loss, and have the characteristics of low cost, wide application range, and good stability, etc.

In the above-mentioned the smelting and casting process of step (1) of the present disclosure, smelting and casting may specifically comprise four steps: pretreating molten iron, converter smelting, RH refining, and continuous casting. In practical implementation, during the steelmaking process, an operator can control the molten iron of blast furnace that has undergone molten iron pretreatment together with an appropriate amount of high-quality scrap steel to be loaded into the converter for rough refining, then perform RH refining to decarburize, deoxidize, desulfurize, adjust the chemical composition of the steel, and perform calcium treatment. During this period, according to the design requirements of the present disclosure, the operator can adjust the design of the steel's chemical composition (especiallyto ensure that Ca, Cr, S, and N meet the design conditions) to obtain molten steel that meets the chemical composition design requirements, and then cast the molten steel into a continuous casting slab with a thickness of 120-250 mm and a width of 800-1400 mm by continuous casting according to the specified size.

The content of the Ca element in steel can be strictly controlled by the above-mentioned smelting and casting processes, and the calcium content in steel is limited to be0.0003-0.01%, preferably 0.0005-0.004%. In this way, after deoxidation, desulfurization, and calcium treatment of the molten steel, the amount of oxides and sulfides in the steel will be significantly reduced, the size of residual oxides and sulfides in the steel will be coarsened, and the harmfulness is significantly reduced. At the same time, in order to achieve good control effect of nitride, it needs to ensure that both the amount and size of the nitride are appropriate; the mechanical strength of the finished steel plate should not be reduced, nor should the grains be refined to deteriorate the electromagnetic property. Therefore, in the above-mentioned heating and rolling process of step (2) according to the present disclosure, when the continuous casting slab is heated in the heating furnace and the temperature is raised to 1020° C. or more, the heating rate of the continuous casting slab is controlled to be 0.8-2.0° C./min.

It should be noted that, within this temperature range, when the heating rate of the continuous casting slab is lower than 0.8° C./min, the solid solution content of AlN inclusions, especially Cr₂N inclusions, will significantly increase; Correspondingly, during the subsequent finish rolling and coiling processes, as the temperature of the steel plate decreases, AlN and Cr₂N inclusions will reprecipitate, at this time, the size of the precipitations is small and the quantity of the precipitations is significantly increased, so that the cleanliness of the steel is significantly reduced. At the same time, within this temperature range, the heating rate should not be too high. When the heating rate is higher than 2.0° C./min, the solid solution content of AlN inclusions, especially Cr₂N inclusions, will be significantly decreased. At this time, the fine AlN inclusions, especially Cr₂N inclusions precipitated at the end of casting solidification of the molten steel cannot be fully dissolved and still exist in a single form and a small size, which will harm the recrystallization and the formation of favorable texture of hot-rolled microstructure.

Moreover, considering the actual situation that during the temperature decreasing process of the continuous casting slab from a high soaking temperature to after rough rolling and finish rolling, the closer to the end of rolling, the lower the temperature of the hot-rolled steel plate, the smaller the size of the precipitated nitride and the greater the harm, when designing, the inventors also should control the final rolling temperature ≥880° C. during the hot rolling process to ensure that nitrides are fully precipitated at a high temperature stage as much as possible; Meanwhile, the residence time after final rolling and before laminar flow cooling is required to be controlled to be 5-40s, to promote the uniform growth and controlled size of the previously precipitated nitrides.

Due to this heating and rolling process, nitrides in the steel are mainly single Cr₂N, AlN, TiN, and there is a small amount of composite inclusions formed by at least two of AlN, Cr₂N and TiN. Wherein the volume ratio of nitride inclusions [N]_{I} in the steel to all of oxide inclusions [O]_{I}, sulfide inclusions [S]_{I}, and nitride inclusions [N]_{I} in the steel satisfies: 0.42≤[N]_{I}/([O]_{I}+[S]_{I}[N]_{I})≤0.85.

Meanwhile, the volume ratio of nitride inclusions with a size of 0.2-0.5 μm to oxide inclusions, sulfide inclusions and nitride inclusions with a size of 0.2-2.0 μm can satisfy: 0.7-1.0.

It should be noted that the Ti in the above-mentioned TiN inclusions originates from the inevitable Ti with an extremely low content in the steel. Due to that Ti is an impurity element with an extremely low content in the present disclosure, it is not specifically described or limited in the part of the design of element composition of the present disclosure.

In addition, it should also be noted that in some embodiments of the above-mentioned manufacturing process of the present disclosure, the hot-rolled steel plate obtained by step (2), after normalizing annealing at 830-1000° C. for 10-300s under a 100% nitrogen atmosphere, can be rolled to a target thickness of 0.15-0.35 mm by a single cold rolling, or rolled to a target thickness of 0.15-0.35 mm by a first cold rolling+intermediate annealing+a second cold rolling. Finally, after the above-mentioned cold-rolled steel plate can be further controlled to be subjected to continuous annealing of 800-1000° C.×(10-120) s in a nitrogen-hydrogen mixed atmosphere with an H₂ content of 30% or more and subsequent insulation coating, the desired non-oriented electrical steel plate with thin specification, high-strength, low iron loss and high magnetic induction can be obtained.

Compared to prior art, the non-oriented electrical steel plate and manufacturing method therefor according to the present disclosure have the following advantages and beneficial effects:

In the non-oriented electrical steel plate according to the present disclosure, the inventors have optimized the chemical element composition ratio and related manufacturing processes. The non-oriented electrical steel plate produced by the method herein has the characteristics of thin specification, high strength, low iron loss, and high magnetic induction. After continuous annealing, the non-oriented electrical steel plate has excellent yield strength and tensile strength, and can be well applied in high-frequency and high-speed motors with 20000 rpm or less.

In the present disclosure, the non-oriented electrical steel plate designed also has the characteristics of low cost, wide application range, and good stability and so on. The non-oriented electrical steel plate has a yield strength of ≥600 MPa, a tensile strength of ≥700 MPa, an iron loss P_{10/400} of ≤18.0 W/kg, a magnetic induction B₅₀₀₀ of ≥1.62T, and has good promotion prospects and application value.

### BRIEF DESCRIPTION OF THE DRAWINGS

FIG. 1 schematically shows a relationship between [N]_{I}/([O]_{I}+[S]_{I}+[N]_{I}) and the yield strength of the finished steel plate in the non-oriented electrical steel plate according to the present disclosure.

FIG. 2 schematically shows a relationship between nitrides of 0.2-0.5 μm/(oxide inclusions, sulfide inclusions and nitride inclusions of 0.2-2.0 μm) and the magnetic induction B₅₀₀₀ of the finished steel plate in the non-oriented electrical steel plate according to the present disclosure.

FIG. 3 schematically shows a relationship between the hot rolling heating rate and the quantity of inclusions in the non-oriented electrical steel plate according to the present disclosure.

FIG. 4 shows a microstructure image of the comparative steel of Comparative Example 1.

FIG. 5 shows a microstructure image of the finished non-oriented electrical steel plate of Example 10.

### DETAILED DESCRIPTION

The non-oriented electrical steel plate and manufacturing method therefor according to the present disclosure will be further explained and illustrated with reference to the accompanying drawings of the description and specific examples. However, the explanations and illustrations do not constitute an undue limitation on the technical solutions of the present disclosure.

### Examples 1-12 and Comparative Examples 1-5

Table 1 lists the mass percentage of chemical elements in the non-oriented electrical steel plates of Examples 1-12 and the comparative steel plates of Comparative Examples 1-5.

TABLE 1
(wt %, the balance being Fe and inevitable impurities other than P, S, O, N)

| | chemical elements | | | | | | | | | |
|---|---|---|---|---|---|---|---|---|---|---|
| No. | C | Si | Mn | S | Al | Ca | Cr | N | P | O |
| Example 1 | 0.0022 | 2.03 | 0.86 | 0.0018 | 1.51 | 0.0030 | 0.39 | 0.0017 | 0.02 | 0.0016 |
| Example 2 | 0.0027 | 3.41 | 0.53 | 0.0012 | 0.47 | 0.0047 | 0.15 | 0.0037 | 0.01 | 0.0011 |
| Example 3 | 0.0033 | 3.15 | 0.16 | 0.0004 | 1.23 | 0.0019 | 0.04 | 0.0009 | 0.01 | 0.0024 |
| Example 4 | 0.0019 | 3.72 | 0.05 | 0.0007 | 0.17 | 0.0099 | 0.39 | 0.0016 | 0.01 | 0.0047 |
| Example 5 | 0.0015 | 2.98 | 0.55 | 0.0014 | 1.07 | 0.0042 | 0.02 | 0.0028 | 0.01 | 0.0018 |
| Example 6 | 0.0039 | 3.25 | 0.27 | 0.0016 | 0.27 | 0.0005 | 0.10 | 0.0010 | 0.01 | 0.0005 |
| Example 7 | 0.0018 | 3.45 | 0.38 | 0.0002 | 0.001 | 0.0008 | 0.005 | 0.0040 | 0.01 | 0.0011 |
| Example 8 | 0.0022 | 2.77 | 0.99 | 0.0020 | 0.16 | 0.0040 | 0.18 | 0.0005 | 0.02 | 0.0011 |
| Example 9 | 0.0013 | 3.79 | 0.06 | 0.0012 | 0.002 | 0.0022 | 0.27 | 0.0019 | 0.01 | 0.0007 |
| Example 10 | 0.0010 | 3.58 | 0.25 | 0.0009 | 0.82 | 0.0032 | 0.14 | 0.0012 | 0.02 | 0.0013 |
| Example 11 | 0.0032 | 3.12 | 0.31 | 0.0018 | 0.99 | 0.0077 | 0.31 | 0.0026 | 0.01 | 0.0029 |
| Example 12 | 0.0020 | 3.62 | 0.13 | 0.0011 | 0.14 | 0.0003 | 0.08 | 0.0018 | 0.01 | 0.0015 |
| Comparative | 0.0028 | 3.47 | 1.22 | 0.0025 | 0.37 | — | 0.05 | 0.0027 | 0.01 | 0.0023 |
| Example 1 | | | | | | | | | | |
| Comparative | 0.0008 | 3.90 | 0.37 | 0.0019 | 0.91 | 0.0003 | 0.37 | 0.0011 | 0.02 | 0.0009 |
| Example 2 | | | | | | | | | | |
| Comparative | 0.0028 | 3.21 | 0.08 | 0.0011 | 0.002 | 0.0014 | 0.18 | 0.0009 | 0.01 | 0.0015 |
| Example 3 | | | | | | | | | | |
| Comparative | 0.0037 | 2.65 | 0.95 | 0.0003 | 1.47 | 0.0092 | 0.71 | 0.0051 | 0.01 | 0.0008 |
| Example 4 | | | | | | | | | | |
| Comparative | 0.0044 | 2.23 | 0.18 | 0.0008 | 1.82 | 0.0032 | 0.01 | 0.0036 | 0.02 | 0.0012 |
| Example 5 | | | | | | | | | | |

The non-oriented electrical steel plates of Examples 1-12 and the comparative steel plates of Comparative Examples 1-5 are manufactured by the following steps:
(1) Smelting and casting according to the chemical composition ratios shown in Table 1: during the steelmaking process, the blast furnace molten iron that has undergone molten iron pretreatment and a appropriate amount of high-quality scrap steel are loaded into the converter for rough refining, then followed by performing RH refining to decarburize, deoxidize, desulfurize, adjust the chemical composition of the steel, and perform calcium treatment. During the process, according to the design requirements of the present disclosure, the design of the steel's chemical composition is adjusted (especially ensure that Ca, Cr, S, and N meet the design conditions) to obtain molten steel that meets the chemical composition design requirements. Then, a continuous casting slab with a thickness of 120-250 mm and a width of 800-1400 mm is cast by continuous casting according to the specified size.
(2) Heating and rolling: the obtained continuous casting slab is input into a heating furnace for heating and temperature rise. When the continuous casting slabt is heated in the heating furnace and the temperature rises to 1020° C. or more, the heating rate of the continuous casting slab is strictly controlled to be 0.8-2.0° C./min; And the final rolling temperature should be controlled to be ≥880° C., and the residence time after final rolling and before laminar flow cooling should be controlled to be 5-40s.
(3) Normalizing annealing: under a 100% nitrogen atmosphere, the normalizing annealing temperature is controlled to be 830-1000° C. and the normalizing annealing time is controlled to be 60-300s.
(4) Pickling
(5) Cold rolling: rolling to a target thickness of 0.15-0.35 mm by a single cold rolling process, or rolling to a target thickness of 0.15-0.35 mm by a double cold rolling process including a first cold rolling, intermediate annealing, and a second cold rolling.
(6) Continuous annealing: performing continuous annealing in a nitrogen-hydrogen mixed atmosphere with an H₂ content of 30% or more, controlling the continuous annealing temperature to be 800-1000° C., and controlling the continuous annealing time to be 10-120s.
(7) Coating an insulation coating.

It should be noted that in the present disclosure, the chemical compositions and related process parameters of Examples 1-12 all meet the control requirements of the design specification according to the present disclosure; However, in Comparative Examples 1-5, although the comparative steels are also manufactured by the above-mentioned process steps, there are parameters that do not comply with the design of the present disclosure in their chemical element composition and/or related process parameters.

Table 2 lists the specific process parameters in the above-mentioned manufacturing process and final finished product thickness of the non-oriented electrical steel plates of Examples 1-12 and the comparative steel plates of Comparative Examples 1-5.

TABLE 2

| | step(2) | | | | | | |
|---|---|---|---|---|---|---|---|
| | Heating rate when | Final rolling | Residence time after | step(3) | | step(6) | Finished |
| | the temperature | temperature | final rolling and | Normalizing | | Continuous | product |
| | rises to 1020° C. | during rolling | before laminar flow | process | step(5) | annealing process | thickness |
| No. | or more (° C./min) | (° C.) | cooling (s) | (° C. × s) | Cold rolling mode | (° C. × s) | (mm) |
| Example 1 | 0.83 | 900 | 8 | 1000 × 60 | double cold rolling | 1000 × 10 | 0.15 |
| Example 2 | 1.09 | 900 | 10 | 950 × 120 | single cold rolling | 800 × 10 | 0.25 |
| Example 3 | 1.97 | 900 | 15 | 880 × 200 | single cold rolling | 880 × 15 | 0.25 |
| Example 4 | 1.22 | 920 | 5 | 850 × 150 | double cold rolling | 960 × 120 | 0.35 |
| Example 5 | 0.89 | 880 | 8 | 920 × 300 | single cold rolling | 980 × 10 | 0.20 |
| Example 6 | 1.88 | 940 | 12 | 920 × 60 | single cold rolling | 900 × 20 | 0.23 |
| Example 7 | 1.53 | 880 | 40 | 900 × 90 | double cold rolling | 980 × 30 | 0.27 |
| Example 8 | 0.99 | 900 | 20 | 980 × 60 | single cold rolling | 980 × 90 | 0.18 |
| Example 9 | 1.37 | 880 | 15 | 830 × 90 | double cold rolling | 960 × 60 | 0.33 |
| Example 10 | 1.12 | 880 | 5 | 880 × 60 | double cold rolling | 820 × 30 | 0.25 |
| Example 11 | 2.00 | 900 | 10 | 900 × 150 | single cold rolling | 850 × 60 | 0.30 |
| Example 12 | 1.00 | 920 | 8 | 900 × 90 | double cold rolling | 880 × 20 | 0.35 |
| Comparative | 0.94 | 900 | 4 | 850 × 90 | single cold rolling | 900 × 30 | 0.25 |
| Example 1 | | | | | | | |
| Comparative | 2.5 | 880 | 8 | 900 × 120 | double cold rolling | 800 × 10 | 0.35 |
| Example 2 | | | | | | | |
| Comparative | 1.57 | 820 | 35 | 1000 × 60 | single cold rolling | 980 × 90 | 0.50 |
| Example 3 | | | | | | | |
| Comparative | 0.49 | 940 | 15 | 940 × 300 | double cold rolling | 1000 × 20 | 0.35 |
| Example 4 | | | | | | | |
| Comparative | 1.26 | 880 | 55 | 960 × 60 | double cold rolling | 850 × 60 | 0.15 |
| Example 5 | | | | | | | |

The finally obtained finished non-oriented electrical steel plates of Examples 1-12 and the comparative steel plates of Comparative Examples 1-5 are sampled respectively. And the steel plate samples of Examples 1-12 and Comparative Examples 1-5 are observed and analyzed. It is observed and found that the steels of Examples and Comparative Examples all have inclusions such as oxide inclusions, sulfide inclusions and nitride inclusions.

Through further analysis and testing, the volume ratios of nitride inclusions [N]_{I} to all of oxide inclusions [O]_{I}, sulfide inclusions [S]_{I}, and nitride inclusions [N]_{I} and the volume ratios of nitride inclusions with a size of 0.2-0.5 μm to oxide inclusions, sulfide inclusions, and nitride inclusions with a size of 0.2-2.0 μm in the steel plates of each example and comparative example can be respectively obtained. The relevant results of observation and analysis are listed in Table 3 below.

The analysis and testing method for inclusions is carried out according to the National Standard GBT 10561.

Table 3 lists the observation and analysis results of the inclusions of steel plates of each example and comparative example.

TABLE 3

| No. | A | B |
|---|---|---|
| Example 1 | 0.61 | 0.72 |
| Example 2 | 0.52 | 0.99 |
| Example 3 | 0.79 | 0.81 |
| Example 4 | 0.58 | 0.90 |
| Example 5 | 0.42 | 0.76 |
| Example 6 | 0.81 | 0.71 |
| Example 7 | 0.44 | 0.82 |
| Example 8 | 0.83 | 0.88 |
| Example 9 | 0.85 | 0.91 |
| Example 10 | 0.49 | 0.73 |
| Example 11 | 0.65 | 0.94 |
| Example 12 | 0.70 | 0.83 |
| Comparative Example 1 | 0.37 | 0.83 |
| Comparative Example 2 | 0.48 | 0.64 |
| Comparative Example 3 | 0.73 | 0.92 |
| Comparative Example 4 | 0.92 | 0.71 |
| Comparative Example 5 | 0.81 | 0.59 |

Note:
In the above-mentioned Table 3, “A” represents [N]_{I}/([O]_{I} + [S]_{I} + [N]_{I}); “B” represents the volume ratio of nitride inclusions with a size of 0.2-0.5 μm to oxide inclusions, sulfide inclusions, and nitride inclusions with a size of 0.2-2.0 μm.

It was observed that the nitride inclusions are mainly single Cr₂N, AlN, and TiN, and there are also a small amount of composite inclusions formed by at least two of AlN, Cr₂N, and TiN in the non-oriented electrical steel plates manufactured in Examples 1-12.

After the testing for the inclusions in the sample steel plates of each example and comparative sample, it is found that, it can be seen from the above-mentioned Table 3 that, in Examples 1-12, the ratio of the volume percentage content of nitride inclusions [N]_{I} to that of all the oxide inclusions [O]_{I}, sulfide inclusions [S]_{I}, and nitride inclusions [N]_{I} in the steel is 0.42-0.85 specifically; Moreover, the ratio of nitride inclusions with a size of 0.2-0.5 μm to oxide inclusions, sulfide inclusions, and nitride inclusions with a size of 0.2-2.0 u m in steel is 0.71-0.99.

Correspondingly, after the above-mentioned observation and analysis for inclusions are completed, the final manufactured non-oriented electrical steel plates of Examples 1-12 and the comparative steel plates of Comparative Examples 1-5 can be sampled again, and the sample steel plates of Examples 1-12 and Comparative Examples 1-5 are tested for the mechanical properties, magnetic induction B₅₀₀₀, and iron loss P_{10/400} of. The test results obtained are listed in the following Table 4.

The relevant performance testing methods are as follows:

Tensile test: According to the “National Standard GB/T 228.1-2010, Metallic Materials Tensile Test Part 1: Room Temperature Test Method”, constant temperature test and single sheet test are performed with test temperature controlled to be 20° C. and sample size controlled to be 35 mm×390 mm, to measure the yield strength Y_{S} and tensile strength T_{S} of the steel plates of examples and comparative examples.

Magnetic induction performance test: According to the “National Standard GB/T 3655-2008, magnetic induction performance test is performed using an Epstein square method. The test temperature is controlled to be 20° C. for constant temperature test, the sample size is controlled to be 30 mm×300 mm, and the target mass is 0.5 kg. The magnetic induction B₅₀₀₀ of the steel plates of examples and comparative examples is measured accordingly.

Iron loss performance test: According to the National Standard GB/T 3655-2008, iron loss performance test is performed using an Epstein square method. The test temperature is controlled to be 20° C. for constant temperature test, the sample size is controlled to be 30 mm×300 mm, and the target mass is 0.5 kg. The iron loss P_{10/400} of the steel plates of examples and comparative examples is measured accordingly.

Table 4 lists the test results of yield strength Y_{S}, tensile strength T_{S}, magnetic induction B₅₀₀₀, and iron loss P_{10/400} of the non-oriented electrical steel plates of Examples 1-12 and the comparative steel plates of Comparative Examples 1-5.

TABLE 4

| | Yield | Tensile | Magnetic | Iron loss |
|---|---|---|---|---|
| | strength Y_{S} | strength T_{S} | induction | P_{10/400} |
| No. | (MPa) | (MPa) | B₅₀₀₀ (T) | (W/kg) |
| Example 1 | 613 | 762 | 1.63 | 16.6 |
| Example 2 | 632 | 744 | 1.63 | 15.7 |
| Example 3 | 614 | 749 | 1.63 | 17.1 |
| Example 4 | 652 | 776 | 1.65 | 17.2 |
| Example 5 | 621 | 706 | 1.66 | 16.8 |
| Example 6 | 622 | 741 | 1.65 | 15.7 |
| Example 7 | 641 | 722 | 1.64 | 14.2 |
| Example 8 | 611 | 718 | 1.66 | 16.3 |
| Example 9 | 627 | 737 | 1.65 | 13.9 |
| Example 10 | 641 | 745 | 1.64 | 16.5 |
| Example 11 | 629 | 713 | 1.63 | 15.1 |
| Example 12 | 656 | 785 | 1.64 | 14.7 |
| Comparative | 624 | 734 | 1.59 | 24.7 |
| Example 1 | | | | |
| Comparative | 638 | 725 | 1.58 | 15.8 |
| Example 2 | | | | |
| Comparative | 547 | 679 | 1.58 | 18.9 |
| Example 3 | | | | |
| Comparative | 582 | 711 | 1.60 | 22.1 |
| Example 4 | | | | |
| Comparative | 559 | 658 | 1.62 | 19.4 |
| Example 5 | | | | |

As shown in the above-mentioned Table 4, in the present disclosure, the non-oriented electrical steel plates of Examples 1-12 have a yield strength of 611-656 MPa, a tensile strength of 706-785 MPa, a magnetic induction B₅₀₀₀ of 1.63-1.66T, and an iron loss P_{10/400} of 13.9-17.2W/kg. The comprehensive performance of the non-oriented electrical steel plates of Examples 1-12 is significantly better than that of the comparative steel plates of Comparative Examples 1-5. Since comparative examples 1-5 do not meet the conditions specified by the present technical solution, the implementing effect of Comparative Examples 1-5 is also inferior to that of the present technical solution.

In combination with the datas listed in the above-mentioned Tables 1, 2, 3, and 4, analysis and explanation can be further provided for the five comparative examples manufactured herein.

In Comparative Example 1, the Mn and S elements added to the steel are 1.22% and 0.0025% respectively, which both exceed the upper limits of 1.0% and 0.002% of the design requirements of the present disclosure. Moreover, after hot rolling and final rolling and before laminar flow cooling, the residence time of the continuous casting slab is only 4 seconds, which is lower than the lower limit of 5 seconds of the design requirements of the present disclosure. Correspondingly, the [N]_{I}/([O]_{I}+[S]_{I}+[N]_{I}) in steel is only 0.37, which is lower than the lower limit of 0.42 of the design requirements of the present disclosure. Therefore, the yield strength and tensile strength of the finished steel plate correspondingly manufactured by Comparative Example 1 are both qualified, but the magnetic induction B₅₀₀₀ is lower and the iron loss P_{10/400} is higher, which are 1.59 T and 24.7 W/kg respectively, and do not reach the design requirements of the present disclosure.

In Comparative Example 2, the content of Si element added to the steel is 3.90%, which exceeds the upper limit of 3.8% of the design requirements of the present disclosure. Moreover, during the hot rolling process of the continuous casting slab, the heating rate of the continuous casting slab in the temperature range of 1020° C. or more is 2.5° C./min, which is higher than the upper limit of 2.0° C./min of the design requirements of the present disclosure. Correspondingly, the ratio of nitrides with a size of 0.2-0.5 μm to oxide inclusions, sulfide inclusions, and nitride inclusions with a size of 0.2-2.0 μm in steel is only 0.64, which is lower than the lower limit of 0.70 of the design requirements of the present disclosure. Therefore, the yield strength, tensile strength, and iron loss P_{10/400} of the finished steel plate correspondingly manufactured by Comparative Example 2 are all qualified, but the magnetic induction B₅₀₀₀ is low at 1.58 T, which does not reach the design requirements of the present disclosure.

In Comparative Example 3, the design of chemical composition in the steel is qualified, but during hot rolling, the final rolling temperature of the continuous casting slab is only 820° C., which is lower than the lower limit of 880° C. of the design requirements of the present disclosure. Moreover, the target thickness of the finished steel plate is 0.50 mm, which is higher than the upper limit of 0.35 mm of the design requirements of the present disclosure. Therefore, the yield strength Y_{S}, tensile strength T_{S}, magnetic induction B₅₀₀₀, and iron loss P_{10/400} of the finished steel plate correspondingly manufactured by Comparative Example 3 are unqualified, which are 547 MPa, 679 MPa, 1.58 T, and 18.9W/kg, respectively, and all fail to meet the design requirements of the present disclosure.

In Comparative Example 4, the contents of the Cr and N element added to the steel are 0.71% and 0.0051% respectively, which exceed the upper limits of 0.4% and 0.004% of the design requirements of the present disclosure. Moreover, in the manufacturing process, the heating rate of the continuous casting slab in the temperature range of 1020° C. or more is 0.49° C./min, which is lower than the lower limit of 0.8° C./min of the design requirements of the present disclosure. Correspondingly, the [N]_{I}/([O]_{I}+[S]_{I}+[N]_{I}) in steel is as high as 0.92, which is higher than the upper limit of 0.85 of the design requirements of the present disclosure. Therefore, the yield strength Y_{S}, magnetic induction B₅₀₀₀, and iron loss P_{10/400} of the finished steel plate correspondingly manufactured by Comparative Example 4 are all unqualified, which are 582 MPa, 1.60 T, and 22.1 W/kg, respectively, and fail to meet the design requirements of the present disclosure.

In Comparative Example 5, the contents of C and Al elements added to the steel are 0.0044% and 1.82% respectively, which exceed the upper limit 0.004% of C and the upper limit 1.5% of Al of the design requirements of the present disclosure. Moreover, in the manufacturing process, the residence time after hot rolling and final rolling and before laminar flow cooling of the continuous casting slab is 55 seconds, which is higher than the upper limit of 40 seconds of the design requirements of the present disclosure. Correspondingly, the ratio of nitrides with the size of 0.2-0.5 μm to oxide inclusions, sulfide inclusions, and nitride inclusions with the size of 0.2-2.0 μm in steel is 0.59, which is lower than the lower limit of 0.70 of the design requirements of the present disclosure. Therefore, the yield strength Y_{S}, tensile strength T_{S}, and iron loss P_{10/400} of the finished steel plate correspondingly manufactured by Comparative Example 5 are all unqualified, which are 559 MPa, 658 MPa, and 19.4 W/kg, respectively, and fail to meet the design requirements of the present disclosure.

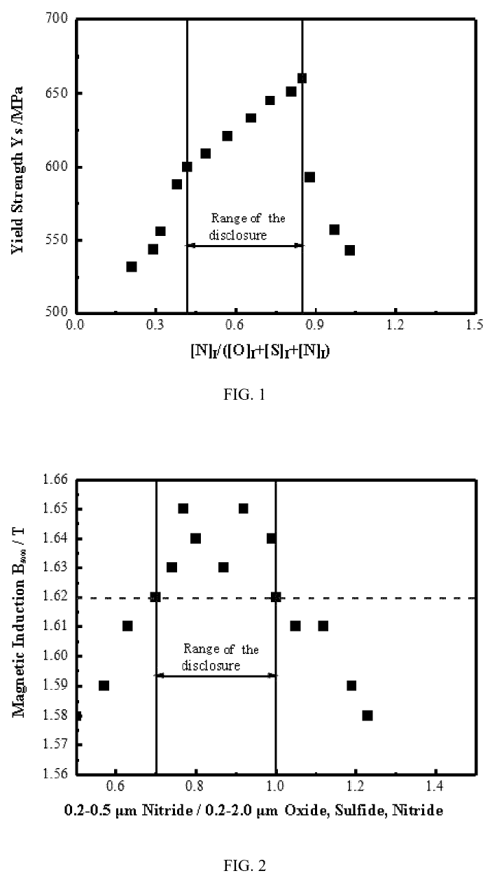

FIG. 1 schematically shows a relationship between [N]_{I}/([O]_{I}+[S]_{I}+[N]_{I}) and the yield strength of the finished steel plate in the non-oriented electrical steel plate according to the present disclosure.

As shown in FIG. 1, it is observed and found that with the increase of [N]_{I}/([O]_{I}+[S]_{I}+[N]_{I}), the yield strength of the finished steel plate increases rapidly, and when the [N]_{I}/([O]_{I}+[S]_{I}+[N]_{I}) reaches 0.42, the yield strength of the finished steel plate can reach 600 MPa. Afterwards, with the increase of [N]_{I}/([O]_{I}+[S]_{I}+[N]_{I}), the yield strength of the finished steel plate continued to increase by the same proportion, and when the [N]_{I}/([O]_{I}+[S]_{I}+[N]_{I}) reaches 0.85, the yield strength of the finished steel plate reaches a maximum. Then, with the further increase of the [N]_{I}/([O]_{I}+[S]_{I}+[N]_{I}), the yield strength of the finished steel plate rapidly decreases, thereby failing to meet the design requirements of the present disclosure.

FIG. 2 schematically shows a relationship between nitrides (0.2-0.5 μm)/oxide inclusions, sulfide inclusions and nitride inclusions (0.2-2.0 μm) and the magnetic induction B₅₀₀₀ of the finished steel plate in the non-oriented electrical steel plate according to the present disclosure.

As shown in FIG. 2, it is observed and found that for the volume percentage ratio of nitride inclusions with the size of 0.2-0.5 μm to all of oxide inclusions, sulfide inclusions, and nitride inclusions with the size of 0.2-2.0 μm, as the parameter values increase, the magnetic induction of the finished steel plate first increases rapidly, and reaches or exceeds the design requirements of 1.62T or more according to the present disclosure in the range of 0.7-1.0; Then the magnetic induction began to decrease rapidly, thereby failing to meet the design requirements for the control of the magnetic induction of the finished steel plate according to the present disclosure.

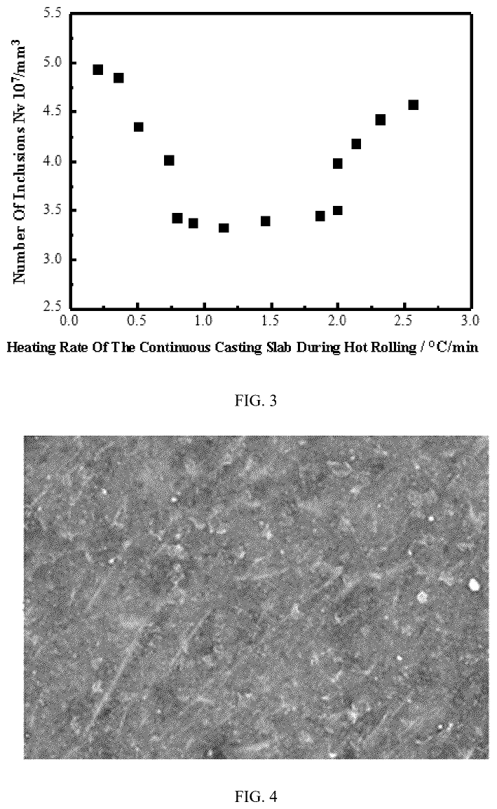

FIG. 3 schematically shows a relationship between the hot rolling heating rate and the quantity of inclusions in the non-oriented electrical steel plate according to the present disclosure.

As shown in FIG. 3, it is observed and found that during the hot rolling process, with the increase of the heating rate of the continuous casting slab, the number of inclusions in the steel first decreases rapidly, and when the heating rate is 0.8° C./min, the quantity of inclusions reaches 3.5×10⁷/mm³ or less, and remains basically stable before 2.0° C./min, and then, the quantity of inclusions begins to increase rapidly, gradually far exceeding 3.5×10⁷/mm³.

FIG. 4 shows a microstructure image of the comparative steel of Comparative Example 1.

As shown in FIG. 4, by observation for the microstructure of the comparative steel of Comparative Example 1, it is found that the inclusions in the steel of Comparative Example 1 have irregular shapes, small sizes, a numerous number, and a clustered distribution, which seriously hinders the growth of grain size during heat treatment annealing, and deteriorates the favorable crystal texture of the finished steel plate, thereby deteriorating the electromagnetic properties.

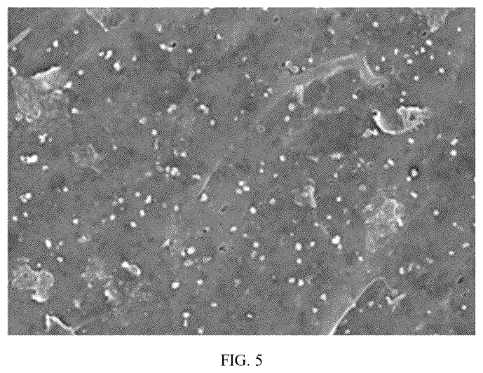

FIG. 5 shows a microstructure image of the finished non-oriented electrical steel plate of Example 10.

As shown in FIG. 5, in this embodiment, in the finished non-oriented electrical steel plate of Example 10, the size of the inclusions is relatively large and uniform, with regular shapes on the whole and a small quantity, which has little effect on the growth of grain size during heat treatment annealing, and is conducive to improve the electromagnetic properties of the finished steel plate.

It should be noted that the prior art part in the protection scope of the present disclosure is not limited to the embodiments given in the application documents, and all prior arts that do not contradict the solution of the present disclosure, including but not limited to the prior patent documents, prior publications, prior public use, etc., can all be included in the protection scope of the present disclosure.

Moreover, the combination of the technical features of the present disclosure is not limited to the combinations described in the claims or the specific embodiments of the present disclosure, and all the technical features of the present disclosure can be freely combined in any way unless contradicted by each other.

It should also be noted that the embodiments listed above are only specific examples of the present disclosure. It is obvious that the present disclosure is not limited to the above embodiments, and similar variations or modifications will be obvious for those skilled in the art or can be directly derived by those skilled in the art based on the the present disclosure, all of which fall within the protection scope of the present disclosure.

1. A non-oriented electrical steel plate, wherein the non-oriented electrical steel plate comprising, in addition to Fe and inevitable impurities, the following chemical elements in percentage by mass:
C: 0.001~0.004%, Si: 2.0~3.8%, Mn: 0.05~1.0%, 0<Al≤1.51%, Ca: 0.0003~0.01%, Cr: 0.005~0.4%.

2. The non-oriented electrical steel plate according to claim 1, wherein the non-oriented electrical steel plate comprises the following chemical elements in percentage by mass:
C: 0.001~0.004%, Si: 2.0~3.8%, Mn: 0.05~1.0%, Al≤1.51%, Ca: 0.0003~0.01%, Cr: 0.005~0.4%, and the balance being Fe and inevitable impurities.

3. The non-oriented electrical steel plate according to claim 1, wherein among the inevitable impurities, P≤0.02%, S≤0.002%, N≤0.004%, O≤0.005%.

4. The non-oriented electrical steel plate according to claim 1, wherein a content of Ca element is 0.0005-0.004%.

5. The non-oriented electrical steel plate according to claim 1, wherein nitride inclusions in the steel include individual Cr₂N, AlN or TiN, and composite inclusions formed by at least two of AlN, Cr₂N and TiN.

6. The non-oriented electrical steel plate according to claim 1, wherein a volume ratio of nitride inclusions [N]_{I} in the steel to all of oxide inclusions [O]_{I}, sulfide inclusions [S]_{I} and nitride inclusions [N]_{I} in the steel satisfies: 0.42≤[N]_{I}/([O]_{I}+[S]_{I}+[N]_{I})≤0.85.

7. The non-oriented electrical steel plate according to claim 1, wherein a volume ratio of nitride inclusions with a size of 0.2 μm-0.5 μm to oxide inclusions, sulfide inclusions and nitride inclusions with a size of 0.2 μm-2.0 μm is 0.7~1.0.

8. The non-oriented electrical steel plate according to claim 1, wherein a thickness of the non-oriented electrical steel plate is 0.15~0.35 mm.

9. The non-oriented electrical steel plate according to claim 1, wherein the non-oriented electrical steel plate has a yield strength of ≥600 MPa, a tensile strength of ≥700 MPa, an iron loss P_{10/400} of ≤18.0 W/kg, a magnetic induction B₅₀₀₀ of ≥1.62T.

10. A method for manufacturing the non-oriented electrical steel plate according to claim 1, wherein the method comprises the following steps:
(1) smelting and casting to obtain a continuous casting slab;
(2) heating and rolling to obtain a steel plate, wherein when the continuous casting slab is heated in the heating furnace and a temperature is raised to 1020° C. or more, a heating rate is controlled to be 0.8~2.0° C./min; a final rolling temperature is ≥880° C., and a residence time after final rolling and before laminar flow cooling is controlled to be 5-40s;
(3) normalizing annealing the steel plate;
(4) pickling;
(5) cold rolling;
(6) continuous annealing to obtain a finished steel plate;
(7) coating an insulation coating on a surface of the finished steel plate.

11. The manufacturing method according to claim 10, wherein in step (3), a temperature of the normalizing annealing is controlled to be 830~1000° C., and a time of the normalizing annealing is 10~300s.

12. The manufacturing method according to claim 10, wherein in step (6), a temperature of the continuous annealing is controlled to be 800~1000° C., and a time of the continuous annealing is 10-120s.

13. The non-oriented electrical steel plate according to claim 2, wherein among the inevitable impurities, P≤0.02%, S≤0.002%, N≤0.004%, O≤0.005%.

14. The non-oriented electrical steel plate according to claim 2, wherein a content of Ca element is 0.0005-0.004%.

15. The non-oriented electrical steel plate according to claim 2, wherein nitride inclusions in the steel include individual Cr₂N, AlN or TiN, and composite inclusions formed by at least two of AlN, Cr₂N and TiN.

16. The non-oriented electrical steel plate according to claim 2, wherein a volume ratio of nitride inclusions [N]_{I} in the steel to all of oxide inclusions [O]_{I}, sulfide inclusions [S]_{I} and nitride inclusions [N]_{I} in the steel satisfies: 0.42≤[N]_{I}/([O]_{I}+[S]_{I}+[N]_{I})≤0.85.

17. The non-oriented electrical steel plate according to claim 2, wherein a volume ratio of nitride inclusions with a size of 0.2 μm-0.5 μm to oxide inclusions, sulfide inclusions and nitride inclusions with a size of 0.2 μm-2.0 μm is 0.7~1.0.

18. The non-oriented electrical steel plate according to claim 2, wherein a thickness of the non-oriented electrical steel plate is 0.15~0.35 mm.

19. The non-oriented electrical steel plate according to claim 2, wherein the non-oriented electrical steel plate has a yield strength of ≥600 MPa, a tensile strength of ≥700 MPa, an iron loss P_{10/400} of ≤18.0 W/kg, a magnetic induction B₅₀₀₀ of ≥1.62T.

20. The manufacturing method according to claim 10, wherein the non-oriented electrical steel plate comprises the following chemical elements in percentage by mass:
C: 0.001~0.004%, Si: 2.0~3.8%, Mn: 0.05~1.0%, Al≤1.51%, Ca: 0.0003~0.01%, Cr: 0.005~0.4%, and the balance being Fe and inevitable impurities.
